(19) United States
(12) Patent Application Publication
(10) Pub. No.: US 2026/0044094 A1
(43) Pub. Date: Feb. 12, 2026

(54) POSITIVELY CHARGED TONER AND TWO-COMPONENT DEVELOPER INCLUDING POSITIVELY CHARGED TONER

(71) Applicant: KYOCERA Document Solutions Inc., Osaka (JP)

(72) Inventor: Kohei YAMAUCHI, Osaka (JP)

(73) Assignee: KYOCERA Document Solutions Inc., Osaka (JP)

(21) Appl. No.: 19/288,702

(22) Filed: Aug. 1, 2025

(30) Foreign Application Priority Data
Aug. 7, 2024 (JP) 2024-130731

(51) Int. Cl. G03G 9/097; G03G 9/087; G03G 9/093; G03G 9/10

(52) U.S. Cl. CPC G03G 9/09725; G03G 9/08711; G03G 9/093; G03G 9/10

(57) ABSTRACT

A positively charged toner includes a toner base particle and an external additive that is adhered to the surface of the toner base particle. The external additive includes a silica particle the surface of which has been positively charged, a strontium titanate particle the surface of which is not positively charged and a resin fine particle that is formed of an acrylic resin. The number average primary particle diameter of each of the silica particle and the strontium titanate particle is 10 nm or more but 40 nm or less. The coverage ratio of the silica particle to the surface region of the toner base particle is 30% or more but 40% or less. The coverage ratio of the strontium titanate particle to the surface region of the toner base particle is 5% or more but 10% or less.

### INCORPORATION BY REFERENCE

This application is based upon and claims the benefit of priority from the corresponding Japanese Patent Application No. 2024-130731 (filed on Aug. 7, 2024), the entire contents of which are incorporated herein by reference.

### BACKGROUND

The present disclosure relates to a positively charged toner and a two-component developer which includes a positively charged toner.

In general, in an electrophotographic method, the surface of an electrostatic latent image carrying member is charged by corona discharge or the like and is then exposed by laser or the like, and thus an electrostatic latent image is formed. The formed electrostatic latent image is developed with a toner to form a toner image. Furthermore, the formed toner image is transferred to a recording medium, and thus a high-quality image is obtained.

### SUMMARY

A positively charged toner of the present disclosure includes a toner base particle and an external additive that is adhered to the surface of the toner base particle. The external additive includes a silica particle the surface of which has been positively charged, a strontium titanate particle the surface of which is not positively charged and a resin fine particle that is formed of an acrylic resin. The number average primary particle diameter of the silica particle is equal to or greater than 10 nm but equal to or less than 40 nm. The number average primary particle diameter of the strontium titanate particle is equal to or greater than 10 nm but equal to or less than 40 nm. The coverage ratio of the silica particle to a surface region of the toner base particle is equal to or greater than 30% but equal to or less than 40%. The coverage ratio of the strontium titanate particle to the surface region of the toner base particle is equal to or greater than 5% but equal to or less than 10%.

Further features of the present disclosure and specific advantages obtained by the present disclosure will become clearer from the following description of an embodiment.

### BRIEF DESCRIPTION OF THE DRAWINGS

FIG. 1 is a diagram showing an example of a cross-sectional structure of a positively charged toner in the present disclosure.

### DETAILED DESCRIPTION

Although an embodiment of the present disclosure will be described below, a problem in a conventional technique will first be described.

As a conventional toner applied to the electrophotographic method, toner particles (toner base particles) are generally used which are obtained by mixing a colorant, a charge control agent, a mold release agent, a magnetic material and the like with a binding resin such as a thermoplastic resin and then kneading, pulverizing and classifying the mixture such that the toner particles have an average particle diameter equal to or greater than 5 μm but equal to or less than 10 μm.

In order to provide fluidity to the toner, to provide suitable charging performance to the toner and to enhance the cleaning properties of the toner from a photosensitive drum, the inorganic fine powder of silica, titanium oxide or the like is externally added to the toner base particles.

An external additive on the surface of the toner undergo changes such as embedment and detachment due to mechanical stress caused by stirring of a development unit. In general, in order to suppress the changes of the external additive such as embedment and detachment, a method is known which uses an external additive of a large diameter as spacer particles. Although silica may be used as the spacer particles, when silica is used for a positively charged toner, silica particles themselves need to be positively charged to provide positive chargeability, with the result that the positive charging causes a charging failure (such as fogging).

In an example of a conventional technique, a toner contains toner particles containing a binding resin and strontium titanate particles and hydrotalcite particles on the surfaces of the toner particles. When the hydrotalcite particles contains fluorine, the area ratio of the strontium titanate particles to the toner particles is assumed to be T1(%) and the area ratio of the hydrotalcite particles to the toner particles is assumed to be H1(%), T1/H1 is 0.15 to 9.00. The conventional technique described above proposes to achieve both charging stabilization and the suppression of a charging difference during the supply of the toner by specifying the area ratio of the strontium titanate particles to the toner particles and the area ratio of the hydrotalcite particles to the toner particles.

In another example of the conventional technique, in a toner for developing an electrostatic latent image, holes are formed which extend from the surfaces of toner base particles toward the inside of the toner base particles. A plurality of particles formed of a metal oxide are stored inside the holes and are adjacent to each other along the longitudinal direction of the holes. The diameter of each of the particles formed of the metal oxide is equal to or greater than 20 nm but equal to or less than 100 nm. The metal oxide is zinc oxide or strontium titanate. The conventional technique described above proposes to obtain charging stability of the toner in a low humidity environment, in a high humidity environment and after long-term storage by specifying the particle diameters of zinc oxide or strontium titanate encapsulated in the toner base particles.

It can be considered that in a positively charged toner, one method for enhancing charging stability against mechanical stress is to increase the coverage ratio of resin fine particles. However, in a case where the resin fine particles are used as an external additive, the adhesiveness of the resin fine particles impairs the fluidity of the toner, and this may cause clogging of the toner when the toner is discharged from a toner container. In the conventional techniques described above, the charging stability of the toner has been considered, but the simultaneous achievements of the charging stability, the charging rise property and the fluidity of the toner has not been considered.

An embodiment of the present disclosure will be described in detail below. Unless otherwise specified, evaluation results (values indicating shapes, physical properties or the like) of powder (more specifically, toner core particles, toner base particles, an external additive, a toner or the like) are the number averages of values obtained by selecting a considerable number of average particles from the powder and performing a measurement on each of the average particles. Unless otherwise specified, the number average particle diameter of the powder is the number average value of the circle-equivalent diameters (the diameter of a circle having the same area as the projected area of a particle) of primary particles measured using a microscope. Unless otherwise specified, the measured value of the volume median diameter (D50) of the powder is a value obtained by performing a measurement using a laser diffraction/scattering particle size distribution measuring device (for example, “LA-750” made by HORIBA, Ltd.). Unless otherwise specified, the measured values of an acid value and a hydroxyl value are values measured according to “JIS (Japanese Industrial Standards) K0070-1992”. Unless otherwise specified, the measured values of a number average molecular weight (Mn) and a mass average molecular weight (Mw) are values measured using gel permeation chromatography.

In the following description, a compound and its derivative may be collectively referred to by adding the term “-based” to the end of the name of the compound. When the name of a polymer is expressed by adding “-based” to the end of the name of a compound, this means that the repeating unit of the polymer is derived from the compound or its derivative. Acrylic and methacrylic may be collectively referred to as “(meth)acrylic”. Acryloyl (CH²═CH—CO—) and methacryloyl (CH²═C(CH³)—CO—) may be collectively referred to as “(meth)acryloyl”.

The toner according to the present embodiment can be suitably used for development of an electrostatic latent image, for example, as a positively charged toner. The toner according to the present embodiment is powder which includes a plurality of toner particles (particles having configurations to be described later). The toner may be used as a one-component developer. By mixing the toner and a carrier with a mixing device (for example, a ball mill), a two-component developer may be prepared. In order to form a high-quality image, it is preferable to use a ferrite carrier as the carrier.

In order to form high-quality images for a long period of time, it is preferable to use magnetic carrier particles which include a carrier core and a resin layer which covers the carrier core. In order to produce magnetic carrier particles, the carrier core may be formed of a magnetic material (for example, ferrite) or may be formed of a resin in which magnetic particles are dispersed. Magnetic particles may be dispersed in a resin layer which covers the carrier core. In order to form a high-quality image, the amount of toner in a two-component developer is preferably equal to or greater than 5 parts by mass but equal to or less than 15 parts by mass with respect to 100 parts of the carrier by mass. The positively charged toner is positively charged by friction with the carrier.

The toner particles included in the toner according to the present embodiment include toner base particles and an external additive which is adhered to the surfaces of the toner base particles. In other words, the toner particles to which the external additive has not been adhered are referred to as the toner base particles. When the toner base particles include shell layers, the particles on which the shell layers have not been formed are referred to as toner core particles. When the toner base particles do not include the shell layers, the toner base particles are also referred to as toner core particles.

The toner according to the present embodiment can be used to form an image in, for example, an electrophotographic apparatus (image forming apparatus). An example of an image forming method using the electrophotographic apparatus will be described below.

An electrostatic latent image is first formed on a photosensitive member (for example, the front layer portion of a photosensitive drum) based on image data. Then, the formed electrostatic latent image is developed using a developer including a toner. In a development step, the toner (toner charged by friction with a carrier or a blade) on a development sleeve (for example, the front layer portion of a development roller in a development unit) arranged in the vicinity of the photosensitive member is adhered to the electrostatic latent image, and thus a toner image is formed on the photosensitive member. Then, in the subsequent transfer step, the toner image on the photosensitive member is directly transferred to a recording medium (for example, paper). Alternatively, the toner image is primarily transferred to an intermediate transfer member (for example, a transfer belt), and then the toner image on the intermediate transfer member is secondarily transferred to the recording medium. Thereafter, the toner is heated, and thus the toner is fixed to the recording medium. Consequently, an image is formed on the recording medium. For example, the toner images of four colors of black, yellow, magenta and cyan are superimposed, and thus a full-color image can be formed.

### [1. Basic Configuration of Toner]

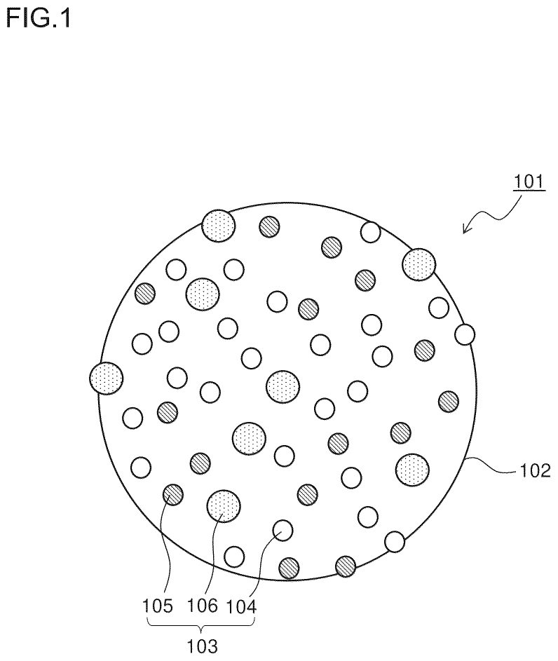

FIG. 1 is a diagram showing an example of a cross-sectional structure of the positively charged toner 101 in the present disclosure. As shown in FIG. 1, the positively charged toner (hereinafter also simply referred to as the toner) 101 in the present disclosure includes the toner base particle 102 and the external additive 103 which is adhered to the surface of the toner base particle 102. The external additive 103 includes a silica particle 104, a strontium titanate particle 105 and a resin fine particle 106.

The silica particle 104 and the strontium titanate particle 105 are added to adjust the chargeability of the toner 101. The silica particle 104 is positively charged. Specifically, the surface of the silica particle 104 is modified with a coupling agent to enhance the positive chargeability (ease of being positively charged) of the silica particle 104. The strontium titanate particle 105 is not positively charged. Hence, the strontium titanate particle 105 has negative chargeability.

The resin fine particle 106 functions as a spacer particle, and reduces the adhesion of the toner particles of the toner 101 or the adhesion of the toner 101 and a carrier to enhance the charging stability. The resin fine particle 106 also reduces the adhesion of the toner 101 and a photosensitive drum and a cleaning blade to enhance cleaning properties.

The resin fine particle 106 is formed of an acrylic resin. The resin fine particle 106 is preferably formed of a silicone modified acrylic resin. The resin fine particle 106 is formed of the silicone modified acrylic resin, and thus silicone included in the particles reduces the adhesion of the resin fine particle 106. Hence, the formation of an aggregate of the resin fine particles 106 can be suppressed. Consequently, it is possible to effectively suppress the slipping through of the external additive at the edge of the cleaning blade.

The number average primary particle diameter of the resin fine particle 106 is preferably equal to or greater than 30 nm but equal to or less than 150 nm, and more preferably equal to or greater than 50 nm but equal to or less than 120 nm. The coverage ratio of the resin fine particle 106 to the surface of the toner base particle 102 (area ratio of a region covered by the resin fine particle 106 to the surface region of the toner base particle 102) is preferably 10 to 40%, and more preferably 15 to 30%.

The toner 101 receives mechanical stress, and thus the external additive 103 is embedded in the toner base particle 102 to gradually lose positive chargeability. In the case of the positively charged silica particle 104, as the silica particle 104 receives mechanical stress, the embedment of the silica particle 104 in the external additive 103 proceeds, and thus the positive chargeability of the toner 101 is lost, with the result that the amount of charging of the entire toner 101 is lowered.

On the other hand, in the case of the strontium titanate particle 105 which is not positively charged, as the strontium titanate particle 105 receives mechanical stress, the embedment of the strontium titanate particle 105 in the toner base particle 102 proceeds, and thus the negative chargeability of the strontium titanate particle 105 is lost, with the result that the amount of charging of the entire toner is increased.

It is found that the variation in the charging performance against mechanical stress is closely related to the particle diameters of the silica particle 104 and the strontium titanate particle 105. Hence, in the present disclosure, the particle diameters of the silica particle 104 and the strontium titanate particle 105 are specified, and thus it is possible to control a change in the amount of charging of the toner 101 against mechanical stress.

Specifically, the number average primary particle diameter of the positively charged silica particle 104 is set equal to or greater than 10 nm but equal to or less than 40 nm. The number average primary particle diameter of the strontium titanate particle 105 which is not positively charged is set equal to or greater than 10 nm but equal to or less than 40 nm.

The variation in the charging performance against mechanical stress is also changed depending on the coverage ratio (area ratio) of the silica particle 104 to the toner base particle 102 and the coverage ratio (area ratio) of the strontium titanate particle 105 to the toner base particle 102. Hence, in the present disclosure, not only the particle diameters of the silica particle 104 and the strontium titanate particle 105 but also the coverage ratio of the silica particle 104 to the toner base particle 102 and the coverage ratio of the strontium titanate particle 105 to the toner base particle 102 are specified, and thus it is possible to control a change in the amount of charging of the toner 101 against mechanical stress.

Specifically, the coverage ratio of the positively charged silica particle 104 is set equal to or greater than 30% but equal to or less than 40%. When the coverage ratio of the silica particle 104 is less than 30%, the initial amount of charging is lowered to cause the scattering of the toner. The fluidity of the toner is also lowered. On the other hand, when the coverage ratio of the silica particle 104 exceeds 40%, the contamination of the external additive in the carrier proceeds, and thus the charging provision performance of the carrier is lowered.

The coverage ratio of the strontium titanate particle 105 which is not positively charged is set equal to or greater than 5% but equal to or less than 10%. When the coverage ratio of the strontium titanate particle 105 is less than 5%, the contribution to the charging stability is decreased. On the other hand, when the coverage ratio of the strontium titanate particle 105 exceeds 10%, a charging rise property is lowered.

The particle diameters and the coverage ratios of the silica particle 104 and the strontium titanate particle 105 are set within the ranges described above, and thus it is possible to appropriately control a change in the amount of charging of the toner 101 against mechanical stress, with the result that it is possible to accomplish the simultaneous achievements of the charging stability, the charging rise property and the fluidity of the toner 101.

### [2. Materials of Toner]

The essential and optional components of the toner in the present disclosure will then be described. The toner core particle includes at least a binding resin. The toner core particle may include, as necessary, a mold release agent, a colorant, a charge control agent, a magnetic powder and the like in the binding resin.

The binding resin of the toner core particle, the mold release agent, the charge control agent, the colorant, the magnetic powder, the resin fine particle of the shell layer, the first resin fine particle of the external additive, a second resin fine particle, a cleaning aid particle and a method for manufacturing the toner in the present disclosure will be sequentially described below.

### (Binding Resin)

The toner core particle of the toner in the present disclosure includes the binding resin. The binding resin which can be contained in the toner particle is not particularly limited as long as the binding resin is a resin which is conventionally used as a binding resin for toner. Specific examples of the binding resin include thermoplastic resins such as a styrene resin, an acrylic resin, a styrene-acrylic resin, a polyethylene resin, a polypropylene resin, a vinyl chloride resin, a polyester resin, a polyamide resin, a polyurethane resin, a polyvinyl alcohol resin, a vinyl ether resin, a N-vinyl resin and a styrene-butadiene resin. Among these resins, in terms of dispersibility of the colorant in the binding resin, the chargeability of the toner and fixability to a sheet, it is preferable to contain at least one of the polyester resin and a styrene-acrylic acid resin, and the polyester resin is more preferable. The polyester resin will be described below.

As the polyester resin, a polyester resin can be used which is obtained by condensation polymerization or co-condensation polymerization of a divalent or trivalent or higher alcohol component and a divalent or trivalent or higher carboxylic acid component. As components used when the polyester resin is synthesized, the following alcohol components and carboxylic acid components can be mentioned.

Specific examples of the divalent or trivalent or higher alcohol component include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

Specific examples of the divalent or trivalent or higher carboxylic acid component include: divalent carboxylic acids such as maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkyls such as n-butylsuccinic acid, n-butenylsuccinic acid, isobutyl succinic acid, isobutenylsuccinic acid, n-octylsuccinic acid, n-octenyl succinic acid, n-dodecylsuccinic acid, n-dodecenylsuccinic acid, isododecylsuccinic acid and isododecenylsuccinic acid and alkenyl succinic acid; and trivalent or higher carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid. These divalent or trivalent or higher carboxylic acid components may be used as ester-forming derivatives such as an acid halide, an acid anhydride and a lower alkyl ester. Here, “lower alkyl” means an alkyl group having 1 to 6 carbon atoms.

When the binding resin is the polyester resin, the softening point of the polyester resin is preferably equal to or greater than 70° C. but equal to or less than 130° C., and more preferably equal to or greater than 80° C. but equal to or less than 120° C. In order to enhance the strength of the toner core and the fixability of the toner, the number average molecular weight (Mn) of the polyester resin is preferably equal to or greater than 1000 but equal to or less than 2000. The molecular weight distribution of the polyester resin (the ratio Mw/Mn of the mass average molecular weight (Mw) to the number average molecular weight (Mn)) is preferably equal to or greater than 9 but equal to or less than 21.

Although as the binding resin, a thermoplastic resin is preferably used because fixability to a sheet is satisfactory, in addition to the use of the thermoplastic resin alone, a crosslinking agent or a thermosetting resin can be added to the thermoplastic resin. By adding a crosslinking agent or a thermosetting resin to introduce a partial crosslinking structure into the binding resin, it is possible to enhance the heat-resistant storage stability, the durability and the like of the toner without decreasing the fixability of the toner. When a thermosetting resin is used, the amount of crosslinked portion (gel amount) of the binding resin extracted using a Soxhlet extractor is preferably equal to or less than 10% by mass with respect to the mass of the binding resin, and more preferably equal to or greater than 0.1% by mass but equal to or less than 10% by mass.

As the thermosetting resin which can be used together with the thermoplastic resin, an epoxy resin or a cyanate resin is preferable. Specific examples of the preferred thermosetting resin include a bisphenol A type epoxy resin, a hydrogenated bisphenol A type epoxy resin, a novolac type epoxy resin, a polyalkylene ether type epoxy resin, a cyclic aliphatic type epoxy resin and a cyanate resin. Two or more of these thermosetting resins can be used in combination.

The glass transition point (Tg) of the binding resin is preferably equal to or greater than 40° C. but equal to or less than 70° C. When the glass transition point is excessively high, the low-temperature fixability of the toner tends to decrease. When the glass transition point is excessively low, the heat-resistant storage stability of the toner tends to decrease.

The glass transition point of the binding resin can be determined from the change point of the specific heat of the binding resin using a differential scanning calorimeter (DSC). More specifically, a differential scanning calorimeter DSC-6200 made by Seiko Instruments Inc. is used as a measuring device, the endothermic curve of the binding resin is measured and thus the glass transition point of the binding resin can be determined. 10 mg of a measurement sample is put into an aluminum pan, and an empty aluminum pan is used as a reference. The glass transition point of the binding resin can be determined from the endothermic curve of the binding resin obtained by performing a measurement in a measurement temperature range equal to or greater than 25° C. but equal to or less than 200° C. at a temperature rise rate of 10° C./min at room temperature and humidity.

The mass average molecular weight (Mw) of the binding resin is typically preferably equal to or greater than 20,000 but equal to or less than 30,000, and more preferably equal to or greater than 30,000 but equal to or less than 2,000,000. The mass average molecular weight of the binding resin can be determined by gel permeation chromatography (GPC) using a calibration curve which has been prepared in advance using a standard polystyrene resin.

### (Mold Release Agent)

The toner core particle may contain a mold release agent in order to enhance the fixability and offset resistance. As the mold release agent, a wax is preferable. Examples of the wax include a carnauba wax, a synthetic ester wax, a polyethylene wax, a polypropylene wax, a fluororesin wax, a Fischer-Tropsch wax, a paraffin wax, a montan wax and a rice wax. Two or more of these mold release agents can be used in combination. Such a mold release agent is added into the toner base particle 102, and thus it is possible to more efficiently suppress the occurrence of offset and image smearing (stain around an image when the image is rubbed).

When the polyester resin is used as the binding resin, in terms of compatibility, one or more mold release agents selected from the group consisting of a carnauba wax, a synthetic ester wax and a polyethylene wax are preferably used as the mold release agent. When a polystyrene resin is used as the binding resin, likewise, in terms of compatibility, a Fischer-Tropsch wax and/or a paraffin wax are preferably used.

The Fischer-Tropsch wax is a linear hydrocarbon compound which has few isostructural molecules and side chains and is manufactured using a Fischer-Tropsch reaction that is the catalytic hydrogenation reaction of carbon monoxide.

Among Fischer-Tropsch waxes, a Fischer-Tropsch wax is more preferable in which its mass average molecular weight is equal to or greater than 1,000, and the bottom temperature of an endothermic peak observed by a DSC measurement is equal to or greater than 100° C. but equal to or less than 120° C. Examples of such a Fischer-Tropsch wax include Sasol Wax C1 (bottom temperature of an endothermic peak: 106.5° C.), Sasol Wax C105 (bottom temperature of an endothermic peak: 102.1° C.), Sasol Wax SPRAY (bottom temperature of an endothermic peak: 102.1° C.) available from Sasol Limited and the like.

The amount of mold release agent used is preferably equal to or greater than 1% by mass but equal to or less than 10% by mass with respect to the total mass of the toner core particles 102. When the amount of mold release agent used is excessively low, it is likely that a desired effect for the suppression of the occurrence of offset and image smearing in the formed image cannot be obtained whereas when the amount of mold release agent used is excessively high, it is likely that the heat-resistant storage stability of the toner is lowered due to the fusion of the toner particles.

### (Colorant)

The toner core particle may include a colorant. As the colorant which can be contained in the toner core particle, a known pigment or dye can be used in accordance with the color of the toner. Specific examples of the preferred colorant which can be added to the toner include: black pigments such as carbon black, acetylene black, lamp black and aniline black; yellow pigments such as yellow lead, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, permanent yellow NCG, tartrazine lake, monoazo yellow and diazo yellow; orange pigments such as red yellow lead, molybdenum orange, permanent orange GTR, pyrazolone orange, Balkan orange and induthrene brilliant orange GK; red pigments such as red iron oxide, cadmium red, red lead, cadmium mercury sulfide, permanent red 4R, lithol red, pyrazolone red, watching red calcium salt, lake red D, brilliant carmine 6B, eosin lake, rhodamine lake B, alizarin lake, brilliant carmine 3B and monoazo red; violet pigments such as manganese violet, fast violet B and methyl violet lake; blue pigments such as Prussian blue, cobalt blue, alkali blue lake, partially chlorinated Victoria blue, fast sky blue, indanthrene blue BC and phthalocyanine blue; green pigments such as chrome green, chromium oxide, pigment green B, malachite green lake and final yellow green G; white pigments such as zinc oxide, titanium dioxide, antimony white and zinc sulfide; and extender pigments such as barite powder, barium carbonate, clay, silica, white carbon, talc and alumina white. Two or more of these colorants can be used in combination, for example, in order to adjust the toner to a desired hue.

The amount of colorant used is preferably equal to or greater than 1% by mass but equal to or less than 10% by mass, and more preferably equal to or greater than 2% by mass but equal to or less than 7% by mass with respect to the total mass of the toner core particles.

The colorant can be used as a master batch in which the colorant is dispersed in a resin material such as a thermoplastic resin beforehand. When the colorant is used as the master batch, a resin included in the master batch is preferably the same type of resin as the binding resin.

### (Charge Control Agent)

The toner core particle may include a charge control agent in order to enhance the charging level of the toner and the charging rise property which is an index of whether the toner can be charged to a predetermined charging level in a short period of time, and to obtain a toner having excellent durability and stability. Since the toner of the present disclosure is a positively charged toner which is positively charged and developed, a positively charged charge control agent is used.

As the type of charge control agent which can be contained in the toner core particle, a charge control agent can be selected as necessary from charge control agents conventionally used for toners to be used. Specific examples of the positively charged charge control agent include: azine compounds such as pyridazine, pyrimidine, pyrazine, orthooxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline; direct dyes formed of azine compounds such as Azin Fast Red FC, Azin Fast Red 12BK, Azin Violet BO, Azin Brown 3G, Azin Light Brown GR, Azin Dark Green BH/C, Azin Deep Black EW and Azin Deep Black 3RL; nigrosine compounds such as nigrosine, a nigrosine salt and a nigrosine derivative; acid dyes formed of nigrosine compounds such as nigrosine BK, nigrosine NB and nigrosine Z; metal salts of naphthenic acid or a higher fatty acid; an alkoxylated amine; an alkyl amide; quaternary ammonium salts such as benzylmethylhexyldecylammonium and decyltrimethylammonium chloride. Among these positively charged charge control agents, the nigrosine compound is particularly preferable because they provide a more rapid charging rise property. Two or more of these positively charged charge control agents can be used in combination.

A resin which includes a quaternary ammonium salt, a carboxylate or a carboxyl group as a functional group can also be used as the positively charged charge control agent. More specifically, examples thereof include a styrene resin including a quaternary ammonium salt, an acrylic resin including a quaternary ammonium salt, a styrene-acrylic resin including a quaternary ammonium salt, a polyester resin including a quaternary ammonium salt, a styrene resin including a carboxylate, an acrylic resin including a carboxylate, a styrene-acrylic resin including a carboxylate, a polyester resin including a carboxylate, a styrene resin including a carboxyl group, an acrylic resin including a carboxyl group, a styrene-acrylic resin including a carboxyl group and a polyester resin including a carboxyl group. The molecular weights thereof are not particularly limited, and an oligomer or a polymer thereof may be used.

Among the resins which can be used as the positively charged charge control agent, a styrene-acrylic resin including a quaternary ammonium salt as a functional group is more preferable because the amount of charging can be easily adjusted to a value within a desired range. Specific examples of an acrylic comonomer which is preferably copolymerized with a styrene unit in a styrene-acrylic resin including a quaternary ammonium salt as a functional group include (meth)acrylic acid alkyl esters such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate and isobutyl methacrylate.

As the quaternary ammonium salt, a unit derived from a dialkylaminoalkyl(meth)acrylate, a dialkyl(meth)acrylamide or a dialkylaminoalkyl(meth)acrylamide through a quaternization step is used. Specific examples of the dialkylaminoalkyl(meth)acrylate include a dimethylaminoethyl (meth)acrylate, a diethylaminoethyl (meth)acrylate, a dipropylaminoethyl (meth)acrylate and a dibutylaminoethyl (meth)acrylate. Specific examples of the dialkyl(meth)acrylamide include a dimethylmethacrylamide. Specific examples of the dialkylaminoalkyl(meth)acrylamid include a dimethylaminopropyl methacrylamide. A hydroxy group-containing polymerizable monomer such as a hydroxyethyl (meth)acrylate, a hydroxypropyl (meth)acrylate, a 2-hydroxybutyl (meth)acrylate or an N-methylol (meth)acrylamide can also be used together during polymerization.

The amount of charge control agent used is typically preferably equal to or greater than 0.1% by mass but equal to or less than 10% by mass with respect to the total mass of the toner core particle. When the amount of charge control agent used is excessively low, since it is difficult to stably charge the toner to a predetermined polarity, the image density of the formed image may fall below a desired value or it may be difficult to maintain the image density for a long period of time. Since the charge control agent is unlikely to be uniformly dispersed, fogging may easily occur in the formed image or an electrostatic latent image carrying unit may easily be contaminated due to components of the toner. When the amount of charge control agent used is excessively high, an image failure in the formed image caused by a charging failure under high temperature and high humidity due to deterioration of environmental resistance, the contamination of the electrostatic latent image carrying unit or the like may easily occur.

### (Magnetic Powder)

The toner core particle may contain a magnetic powder. As the material of the magnetic powder, for example, a ferromagnetic metal (more specifically, iron, cobalt, nickel, an alloy containing one or more of these metals or the like), a ferromagnetic metal oxide (more specifically, ferrite, magnetite, chromium dioxide or the like) or a material which has been subjected to ferromagnetic treatment (more specifically, a carbon material to which a ferromagnetic property has been provided by heat treatment, or the like) can be suitably used. In order to suppress the elution of metal ions (for example, iron ions) from the magnetic powder, it is preferable to use surface-treated magnetic particles as the magnetic powder. One type of magnetic powder may be used alone or a plurality of types of magnetic powder may be used together.

The surface of the toner core particle may be desirably covered with the shell layer. When the shell layer is formed on the toner core particle, the shell layer is formed with the resin fine particles. In order to provide a moderate surface adsorption power to the shell layer, it is particularly preferable that the shell layer contains a resin film mainly formed with an aggregate of resin particles having a glass transition point equal to or greater than 50° C. but equal to or less than 100° C., the number average circularity of heat-resistant particles of the resin film is equal to or greater than 0.55 but equal to or less than 0.75, the heat-resistant particles contain a resin which contains one or more repeating units derived from a styrene monomer, a repeating unit having an alcohol hydroxyl group and a repeating unit derived from a nitrogen-containing vinyl compound and the repeating unit having the highest mass ratio among the repeating units included in the resin contained in the heat-resistant particles is the repeating unit derived from a styrene monomer.

The shell layer of the toner in the present disclosure includes a vinyl resin fine particle (first resin fine particle) which has a relatively small average particle diameter and a vinyl resin fine particle (second resin fine particle) which has a relatively large average particle diameter. The first resin fine particle forms the sea-like region of the shell layer. The second resin fine particle forms the protrusion of the shell layer. The average particle diameter of the first resin fine particle is preferably about 10 nm to 40 nm. The average particle diameter of the second resin fine particle is preferably about 70 nm to 150 nm.

In order to ensure sufficient heat-resistant storage stability, fixability and chargeability of the toner for the shell layer as described above (in other words, a resin film mainly formed with an aggregate of heat-resistant particles), it is preferable to set the thickness of the shell layer equal to or greater than 10 nm but equal to or less than 35 nm. The thickness of the shell layer can be measured by analyzing a TEM (transmission electron microscope) image of the cross section of the toner particle using commercially available image analysis software (for example, “WinROOF” made by Mitani Corporation). When the thickness of the shell layer in one toner particle is not uniform, the thickness of the shell layer is measured at four equally spaced points (specifically, four points obtained by drawing two straight lines orthogonal to each other at substantially the center of the cross section of the toner particle, and causing the two straight lines to intersect the shell layer) and the arithmetic average of the four measured values is assumed to be the evaluation value (thickness of the shell layer) of the toner particle. A boundary between the toner core particle and the shell layer can be confirmed, for example, by selectively dyeing only the shell layer of the toner core particle and the shell layer. When the boundary between the toner core particle and the shell layer is unclear in the TEM image, the boundary between the toner core particle and the shell layer can be clarified by combining the TEM with electron energy loss spectroscopy (EELS) to map characteristic elements contained in the shell layer in the TEM image.

In order to ensure sufficient heat-resistant storage stability, fixability and chargeability of the toner for the shell layer as described above (in other words, a resin film mainly formed with an aggregate of heat-resistant particles), the shell layer preferably covers 50% or more but 80% or less of the surface region of the toner core particle. The area ratio of the region covered by the shell layer to the surface region of the toner core particle can be measured by shooting the surface of the toner particle (for example, the toner particle dyed in advance) with an electron microscope and analyzing the shot image using commercially available image analysis software.

### (External Additive)

In the toner in the present disclosure, the shell layer is formed on the surface of the toner core particle, and is then treated with the external additive. Hereinafter, the toner core particle before being treated with the external additive is referred to as the toner base particle. The toner in the present disclosure includes, as the external additive, the silica particle, the strontium titanate particle and the resin fine particle.

### (Silica Particle)

The surface of the silica particle used in the toner in the present disclosure is modified (positively charged) with a coupling agent to enhance the positive chargeability (ease of being positively charged) of the silica particle. Examples of the coupling agent include silane coupling agents such as dimethylpolysiloxane and 3-aminopropyltrimethoxysilane. The number average primary particle diameter of the silica particle is equal to or greater than 10 nm but equal to or less than 40 nm. The coverage ratio of the silica particle to the surface of the toner base particle is equal to or greater than 30% but equal to or less than 40%.

### (Strontium Titanate Particle)

The strontium titanate particle used in the toner in the present disclosure is not positively charged. The surface of the strontium titanate particle may be modified (hydrophobically treated) with the silane coupling agent. The number average primary particle diameter of the strontium titanate particle is equal to or greater than 10 nm but equal to or less than 40 nm. The coverage ratio of the strontium titanate particle to the surface of the toner base particle is equal to or greater than 5% but equal to or less than 10%.

### (Resin Fine Particle)

The resin fine particle is formed of an acrylic resin. The resin fine particle is preferably formed of a silicone modified acrylic resin. The silicone modified acrylic resin has a structure in which the main chain skeleton of acrylic includes silicone side chains, and is a resin to which a release property and lubricity that are characteristic of silicone have been provided. The silicone modified acrylic resin is a copolymer of a polydiorganosiloxane macromer having an acrylic functional group and a radically polymerizable organic monomer.

Other monomers can be copolymerized with the monomers as described above. Examples of the other monomers copolymerized include: styrene monomers such as styrene, methylstyrene, methoxystyrene, ethylstyrene, propylstyrene, butylstyrene, phenylstyrene and chlorostyrene; acrylic and methacrylic acid ester monomers such as methyl acrylate, ethyl acrylate, propyl acrylate, butyl acrylate, pentyl acrylate, dodecyl acrylate, stearyl acrylate, ethylhexyl acrylate, lauryl acrylate, methyl methacrylate, ethyl methacrylate, propyl methacrylate, butyl methacrylate, pentyl methacrylate, dodecyl methacrylate, stearyl methacrylate, ethylhexyl methacrylate and lauryl methacrylate; and the like.

Among them, a styrene-acrylic acid resin including a styrene monomer and one or more acrylic acid monomers is preferable. The styrene-acrylic acid resin has strong hydrophobicity, and tends to be easily positively charged.

The number average primary particle diameter of the resin fine particle is equal to or greater than 80 nm but equal to or less than 120 nm. The amount of resin fine particle added is 0.3 to 2.0 parts by mass with respect to 100 parts by mass of the toner core particle.

In addition to the silica particle, the strontium titanate particle and the resin fine particle described above, other external additives may be added. The type of external additive which can be added is not particularly limited, and can be selected as necessary from conventional external additives used for toners. Specific examples of the preferred external additive include metal oxides such as alumina, titanium oxide, magnesium oxide, zinc oxide and barium titanate. Two or more of these external additives can be used in combination.

When the toner in the present disclosure is mixed with a carrier to be used as a two-component developer, a silicone coat carrier coated with a silicone resin is used as the carrier, and thus it is possible to reduce carrier contamination caused by adhesion of the external additive to the carrier. This is because the silicone resin of the coating layer has low adhesiveness, and the first resin fine particle and the second resin fine particle (spacer particle) included in the toner are formed of the silicone-modified acrylic resin, and thus the adhesion of the first resin fine particle and the second resin fine particle to the carrier can be suppressed. Since both the coating layer of the carrier and the spacer particle are formed of silicone-based materials, even if the spacer particle is adhered to the carrier, a change in the amount of charging of the carrier can be reduced.

### [Method for Manufacturing Toner]

A method for manufacturing the toner in the present disclosure will then be described. The method for manufacturing the toner includes a method for manufacturing the toner core particle and an external addition treatment method for adhering the external additive to the surface of the toner base particle. The method for manufacturing the toner core particle is not particularly limited as long as the toner core particle is formed to have a predetermined structure. The toner core particle covered with the shell layer may be used as the toner base particle as necessary. As the preferred method for manufacturing the positively charged toner described above, the method for manufacturing the toner core particle, a method for forming the shell layer and the external addition treatment method will be sequentially described below.

### (Method for Manufacturing Toner Core Particle)

The method for manufacturing the toner core particle is not particularly limited as long as arbitrary components such as the colorant, the mold release agent, the charge control agent and the magnetic powder can be satisfactorily dispersed in the binding resin. Examples of the preferred method for manufacturing the toner core particle include a pulverizing method and an agglomeration method.

In the pulverizing method, the binding resin is mixed with the components such as the colorant, the mold release agent, the charge control agent and the magnetic powder using a mixer or the like, then a single-screw or twin-screw extruder or the like is used to melt-knead the binding resin and the components to be mixed with the binding resin and the cooled kneaded product is pulverized and classified. In general, the average particle diameter of the toner core particle is preferably equal to or greater than 5 μm but equal to or less than 10 μm.

In the agglomeration method, in an aqueous medium including the fine particles of the binding resin, the mold release agent, the charge control agent and the colorant, these fine particles are agglomerated until the fine particles have a desired particle diameter. In this way, agglomerated particles including the binding resin, the mold release agent, the charge control agent and the colorant are formed. Then, the resulting agglomerated particles are heated, and thus the components included in the agglomerated particles are unified. In this way, the toner core particle which has the desired particle diameter is obtained.

### (Method for Forming Shell Layer)

When the surface of the toner core particle is covered with the shell layer, the resin particle is adhered to the surface of the toner core particle to form the shell layer.

A more specific method will be described. Hydrochloric acid is added to ion-exchanged water in a mixing device to prepare a weakly acidic aqueous medium (for example, a pH selected from 3 to 5). Then, a resin dispersion liquid (suspension) serving as a shell material and the toner core particles are added to the aqueous medium the pH of which has been adjusted.

Then, while a liquid mixture including the shell material and the toner core particles is being stirred, the temperature of the liquid mixture is increased to a predetermined holding temperature (for example, a temperature selected from 50° C. to 90° C.) at a predetermined rate (for example, a rate selected from 0.1° C./min to 3° C./min). Furthermore, while the liquid mixture is being stirred, the temperature of the liquid is held to the holding temperature described above for a predetermined time (for example, a time selected from 30 minutes to 4 hours). It is considered that while the temperature of the liquid mixture is held high, a reaction (fixation of the shell layer) proceeds between the toner core particles and the shell material. The shell material bonds to the toner core particles to form the shell layer. The shell layer is formed on the surface of the toner core particle in the liquid mixture, and thus the dispersion liquid of the toner base particles is obtained.

### (External Addition Treatment Method)

The method for treating the toner base particles with the external additive is not particularly limited, and the toner base particles can be treated according to a conventionally known method. Specifically, treatment conditions are adjusted such that the particles of the external additive are not embedded in the toner base particles, and a mixer such as a Henschel mixer or a Nauta mixer is used to treat the toner base particles using the external additive.

The toner in the present disclosure described above has excellent fixability and heat-resistant storage stability, and when images are formed over a long period of time in various environments such as an environment of high temperature and high humidity and an environment of low temperature and low humidity, the toner can be charged to the desired amount of charging, with the result that images of desired densities can be formed. Hence, the toner in the present disclosure can be suitably used in various image forming apparatuses. The effects of the present disclosure will be more specifically described below using Examples. The present disclosure is not limited by Examples at all.

### EXAMPLES

### Manufacturing Example 1

### (Manufacturing of Amorphous Polyester Resin)

A reaction container equipped with a thermometer (thermocouple), a dehydration tube, a nitrogen inlet tube and a stirring device (stirring blade) was set in a mantle heater. 150 g of BPA-EO (bisphenol A ethylene oxide 2 mol adduct), 50 g of BPA-PO (bisphenol A propylene oxide 2 mol adduct), 30 g of adipic acid and 54 g of a catalyst (tin (II) 2-ethylhexanoate) were put into the reaction container. After the air inside the reaction container was replaced with nitrogen, the temperature inside the reaction container was raised to 235° C. while the contents were being stirred and a polymerization reaction was carried out until all the monomers were dissolved. After the pressure inside the reaction container was reduced to 8 kPa (absolute pressure), the contents were reacted until a predetermined acid value was reached. Thereafter, the reaction product was taken out of the reaction container and was cooled, and thus an amorphous polyester resin was obtained.

### Manufacturing Example 2

### (Manufacturing of Crystalline Polyester Resin)

A reaction container equipped with a thermometer (thermocouple), a dehydration tube, a nitrogen inlet tube and a stirring device (stirring blade) was set in a mantle heater. 69 g of ethylene glycol, 214 g of sebacic acid and 54 g of a catalyst (tin (II) 2-ethylhexanoate) were put in the reaction container, and the temperature was raised to 235° C. over 2 hours in a nitrogen atmosphere. Thereafter, it was confirmed that the reaction rate had reached 95% or more at 235° C., the mixture was cooled to 160° C. and a mixed solution of 156 g of styrene, 195 g of butyl methacrylate and 0.5 g of dibutyl peroxide was dropped over 1 hour. Thereafter, the mixture was held (aged) at 160° C. for 30 minutes, was then heated to 200° C., was then reacted under a reduced pressure of 8 kPa (absolute pressure) for 1 hour and was then cooled to 180° C. Thereafter, 4-t-butylcatechol was added as a radical polymerization inhibitor, and the temperature was raised to 210° C. over 2 hours. Thereafter, the reaction was carried out at 210° C. for 1 hour, and was then carried out at 40 kPa, with the result that a crystalline polyester resin was obtained.

### Manufacturing Example 3

### (Manufacturing of Toner Base Particle)

### (3-1. Manufacturing of Toner Core Particle)

35 parts by mass of the amorphous polyester resin serving as a binding resin and obtained in Manufacturing Example 1, 12 parts by mass of the crystalline polyester resin obtained in Manufacturing Example 2, 9 parts by mass of an ester wax (Nissan Electol WEP-8 made by NOF Corporation) serving as a mold release agent and 9 parts by mass of carbon black (MA-100 made by Mitsubishi Chemical Group Corporation) serving as a colorant were mixed with an FM mixer (FM-10B made by Nippon Coke and Engineering Co., Ltd.), with the result that a mixture was obtained. Then, the mixture was melt-kneaded with a twin-screw extruder (PCM-30 made by Ikegai Co., Ltd.), and thus a kneaded product was obtained. The melt-kneading was carried out under the conditions of a cylinder temperature of 100° C., a rotation speed of 150 rpm and a material supply rate of 100 g/min. The kneaded product was cooled and coarsely pulverized using a pulverizer (Rotoplex 16/8 type made by Hosokawa Micron Corporation) under the condition of a set particle diameter of 2 mm. The resulting coarsely pulverized product was finely pulverized using a mechanical pulverizer (Turbo Mill made by Freund-Turbo Co., Ltd.). The finely pulverized product was classified using a classifier (Elbow Jet made by Nittetsu Mining Co., Ltd.), and thus a toner core particle having a volume average particle diameter (D50) of 6.7 μm was obtained. The volume average particle diameter of the toner core particle was measured using a Coulter Counter Multisizer 3 (made by Beckman Coulter, Inc.).

### (3-2. Formation of Shell Layer)

100 mL of ion-exchanged water was put into a 1 L three-neck flask equipped with a thermometer and a stirring blade, and then the temperature inside the flask was held at 30° C. using a water bath. Then, 10 g of an aqueous solution of an oxazoline group-containing polymer (Epocross WS-300 made by Nippon Shokubai Co., Ltd., a solid content concentration of 10% by weight) was put as a raw material of the shell layer into the flask, and was sufficiently stirred, thereafter 100 g of the toner core particles obtained in 3-1 was added and the contents of the flask were stirred at a rate of 200 rpm for 1 hour. Then, 100 mL of ion-exchanged water was added into the flask. After 4 mL of a 1% aqueous ammonia solution was added, the temperature inside the flask was raised to 60° C. at a rate of 0.5° C./min while the contents of the flask were being stirred at 150 rpm. After the temperature was raised, the contents of the flask were continuously stirred for 1 hour at the same temperature at a stirring rate of 100 rpm. After completion of the stirring, a 1% aqueous ammonia solution was added into the flask to adjust the pH of the contents of the flask to 7, and the contents were cooled to room temperature, with the result that a dispersion liquid containing the toner base particles was obtained.

### (3-3. Washing Step)

A washing method is not particularly limited, and for example, a Buchner funnel was used to filter and collect a wet cake of the toner base particles from a dispersion liquid including the toner base particles. This wet cake was dispersed again in ion-exchanged water to wash the toner base particles. The same washing operation for the toner base particles using ion-exchanged water was repeated five times.

### (3-4. Drying Step)

A drying method is not particularly limited, and examples thereof include a method in which the wet cake of the toner base particles obtained in 3-3 was supplied to a continuous surface modification device (Coatmizer made by Freund Corporation), and thus the wet cake was dried to obtain the toner base particles. Drying conditions using the Coatmizer were a hot air temperature of 45° C. and a blower volume of 2 m³/min.

### Manufacturing Example 4

### (Manufacturing of Silica Particle)

100 g of dimethylpolysiloxane and 100 g of 3-aminopropyltrimethoxysilane (made by Shin-Etsu Chemical Co., Ltd.) were dissolved in 200 g of toluene. This solution was diluted 10 times, and the obtained diluted solution was gradually dropped into 200 g of fumed silica corresponding to particle diameters while being stirred, with the result that the resulting mixture was obtained. Furthermore, while the mixture was being stirred, ultrasonic waves were applied to the mixture for 30 minutes. The mixture to which ultrasonic waves had been applied was heated to 150° C. using a constant temperature oven. Then, toluene was distilled away from the mixture using a rotary evaporator, and thus a solid material was obtained. The solid material obtained was dried using a vacuum dryer at a set temperature of 50° C. until a weight loss ceased. The dried solid material was heated in an electric furnace in a nitrogen gas flow at a set temperature of 200° C. for 3 hours. The heated solid material was crushed using a jet mill and was collected using a bag filter, and thus positively charged silica particles were obtained.

### Manufacturing Example 5

### (Manufacturing of Strontium Titanate Particle)

A mineral acid peptized product of a hydrolyzed titanium compound and a water-soluble compound containing strontium were prepared, and thus particles mainly formed of strontium titanate were synthesized. Then, the surface was treated with a silane coupling agent, and thus strontium titanate particles which corresponded to particle diameters and was not positively charged were produced.

### Manufacturing Example 6

### (Manufacturing of Toner)

100 parts by mass of the toner base particles obtained in Manufacturing Example 3, the silica particles obtained in Manufacturing Example 4, the strontium titanate particles obtained in Manufacturing Example 5 and 0.2 parts by mass of acrylic resin fine particles were mixed for 5 minutes using a 10 L FM mixer (FM-10B made by Nippon Coke & Engineering Co., Ltd.), and thus the external additive (the silica particles and the strontium titanate particles) was adhered to the surfaces of the toner base particles. The amounts of silica particles and strontium titanate particles added were adjusted such that the coverage ratios to the toner base particles were predetermined values. The obtained powder was sieved using a 200 mesh (opening size of 75 μm) sieve. The types of silica particles and strontium titanate particles and the added amounts were changed as necessary, and thus toners in Examples 1 to 8 and Comparative Examples 1 to 24 were obtained.

### [Measurements of Average Particle Diameters and Coverage Ratios of Silica Particle and Strontium Titanate Particle]

Using a scanning electron microscope (Regulus 8200 made by Hitachi High-Tech Corporation) equipped with an energy dispersive X-ray analyzer (EDX AZtec 4.1 made by Oxford Instruments), 10 sheets of images of toner particles to be measured and element mapping images (magnification: 10,000 times) were produced, and the average particle diameters of the silica particles and the strontium titanate particles and the coverage ratios to the toner base particles were calculated from the average value of the 10 sheets.

### [Evaluations of Charging Stability, Fluidity and Charging Rise Property of Toner]

The charging stability, the fluidity and the charging rise property of the toners in Examples 1 to 8 and the toners in Comparative Examples 1 to 24 were evaluated according to the following methods.

### (Charging Stability)

A Cu—Zn ferrite carrier (F-80 made by Powdertech Co., Ltd.) was added to each of the toners in Examples 1 to 8 and Comparative Examples 1 to 24, and thus a two-component developer having a toner concentration of 10% by mass was prepared. The prepared developer was allowed to stand overnight in an environment of room temperature and humidity (at a temperature of 20° C. and a relative humidity of 65% RH). The developer which had been allowed to stand was mixed for 5 minutes and 30 minutes using a mixing device (Turbula Mixer made by WAB Co., Ltd.). The amount of charging of the toner in the developer after being mixed was measured using a Q/m meter (Model 210HS-2A made by Trek Corporation). The ratio of the amount of charging Q₃₀ after 30 minutes of mixing to the amount of charging Q₅ after 5 minutes of mixing (=Q₃₀/Q₅×100) was calculated as an index of charging stability. The evaluation criteria for charging stability were as follows.
∘ (satisfactory): the ratio of the amount of charging Q₃₀ to the amount of charging Q₅ was equal to or greater than 80%
x (unsatisfactory): the ratio of the amount of charging Q₃₀ to the amount of charging Q₅ was less than 80%

### (Fluidity)

Using a powder measuring device (powder tester made by Hosokawa Micron Corporation), 10.0 g of each of the toners in Examples 1 to 8 and Comparative Examples 1 to 24 which had been left for 12 hours in an environment of room temperature and humidity (at a temperature of 23° C. and a relative humidity 60% RH) was placed on a sieve having an opening of 60 μm, vibration was applied for 10 seconds at a frequency of 60 Hz with an amplitude of 1 mm and the fluidity was calculated according to the following formula. As the calculated value was higher, the fluidity was more satisfactory.

$$fluidity ( \% ) = \{ ( 10. ( g ) - mass of toner left on sieve ( g ) ) / 10. ( g ) \} \times 100$$

The evaluation criteria for fluidity were as follows.
∘ (satisfactory): the calculated value was equal to or greater than 90%
x (unsatisfactory): the calculated value was less than 90%

### (Charging Rise Property)

The Cu—Zn ferrite carrier (F-80 made by Powdertech Co., Ltd.) was added to each of the toners in Examples 1 to 8 and Comparative Examples 1 to 24, and thus the two-component developer having a toner concentration of 10% by mass was prepared. The prepared developer was allowed to stand overnight in an environment of room temperature and humidity (at a temperature of 20° C. and a relative humidity of 65% RH). The developer which had been allowed to stand was mixed for 1 minute and 5 minutes using the mixing device (Turbula Mixer made by WAB Co., Ltd.). The amount of charging of the toner in the developer after being mixed was measured using the Q/m meter (Model 210HS-2A made by Trek Corporation). The ratio of the amount of charging Q₁ after 1 minute of mixing to the amount of charging Q₅ after 5 minutes of mixing (=Q₁/Q₅×100) was calculated as an index of the charging rise property. The evaluation criteria for the charging rise property were as follows.
∘ (satisfactory): the ratio of the amount of charging Q₁ to the amount of charging Q₅ was equal to or greater than 80%
x (unsatisfactory): the ratio of the amount of charging Q₁ to the amount of charging Q₅ was less than 80%

The results of the evaluations of the charging stability, the fluidity and the charging rise property of the toners in Examples 1 to 8 and Comparative Examples 1 to 24 are shown in Table 1 together with the particle diameters, the added amounts and the coverage ratios of the silica particles and the strontium titanate particles used in the manufacturing of the toners.

Table 1 is as follows. “EX1” represents Example 1, “EX2” represents Example 2, “EX3” represents Example 3, “EX4” represents Example 4, “EX5” represents Example 5, “EX6” represents Example 6, “EX7” represents Example 7, “EX8” represents Example 8, “CEX1” represents Comparative Example 1, “CEX2” represents Comparative Example 2, “CEX3” represents Comparative Example 3, “CEX4” represents Comparative Example 4, “CEX5” represents Comparative Example 5, “CEX6” represents Comparative Example 6, “CEX7” represents Comparative Example 7, “CEX8” represents Comparative Example 8, “CEX9” represents Comparative Example 9, “CEX10” represents Comparative Example 10, “CEX11” represents Comparative Example 11, “CEX12” represents Comparative Example 12, “CEX13” represents Comparative Example 13, “CEX14” represents Comparative Example 14, “CEX15” represents Comparative Example 15, “CEX16” represents Comparative Example 16, “CEX17” represents Comparative Example 17, “CEX18” represents Comparative Example 18, “CEX19” represents Comparative Example 19, “CEX20” represents Comparative Example 20, “CEX21” represents Comparative Example 21, “CEX22” represents Comparative Example 22, “CEX23” represents Comparative Example 23 and “CEX24” represents Comparative Example 24.

TABLE 1

| | Particle | | Added amount | | Coverage | | | | Charging |
|---|---|---|---|---|---|---|---|---|---|
| | diameter [nm] | | [mass %] | | ratio [%] | | Charging | | rise |
| | Silica | SrTiO₃ | Silica | SrTiO₃ | Silica | SrTiO₃ | stability | Fluidity | property |
| EX1 | 10 | 10 | 0.8 | 0.3 | 30 | 5 | ∘/80 | ∘/92 | ∘/84 |
| EX2 | 10 | 10 | 1.2 | 0.6 | 40 | 10 | ∘/93 | ∘/95 | ∘/91 |
| EX3 | 10 | 40 | 0.8 | 0.5 | 30 | 5 | ∘/82 | ∘/91 | ∘/86 |
| EX4 | 10 | 40 | 1.2 | 0.9 | 40 | 10 | ∘/91 | ∘/95 | ∘/94 |
| EX5 | 40 | 40 | 1.0 | 0.5 | 30 | 5 | ∘/84 | ∘/93 | ∘/86 |
| EX6 | 40 | 40 | 1.5 | 0.9 | 40 | 10 | ∘/90 | ∘/96 | ∘/97 |
| EX7 | 40 | 10 | 1.0 | 0.3 | 30 | 5 | ∘/82 | ∘/92 | ∘/88 |
| EX8 | 40 | 10 | 1.5 | 0.6 | 40 | 10 | ∘/93 | ∘/95 | ∘/95 |
| CEX1 | 10 | 10 | 0.6 | 0.3 | 25 | 5 | ∘/95 | x/85 | x/74 |
| CEX2 | 10 | 40 | 0.6 | 0.5 | 25 | 5 | ∘/97 | x/83 | x/76 |
| CEX3 | 40 | 40 | 1.0 | 0.4 | 30 | 3 | x/78 | ∘/92 | ∘/83 |
| CEX4 | 40 | 10 | 1.0 | 0.2 | 30 | 3 | x/78 | ∘/91 | ∘/83 |
| CEX5 | 10 | 10 | 1.5 | 0.6 | 45 | 10 | x/73 | ∘/97 | ∘/83 |
| CEX6 | 10 | 40 | 1.5 | 0.9 | 45 | 10 | x/71 | ∘/98 | ∘/83 |
| CEX7 | 40 | 40 | 1.5 | 1.2 | 40 | 15 | ∘/96 | ∘/96 | x/71 |
| CEX8 | 40 | 10 | 1.5 | 0.9 | 40 | 15 | ∘/94 | ∘/97 | x/71 |
| CEX9 | 5 | 10 | 0.7 | 0.3 | 30 | 5 | x/78 | ∘/90 | ∘/81 |
| CEX10 | 5 | 10 | 1.1 | 0.6 | 40 | 10 | x/74 | ∘/94 | ∘/82 |
| CEX11 | 5 | 40 | 0.7 | 0.5 | 30 | 5 | x/76 | ∘/93 | ∘/82 |
| CEX12 | 5 | 40 | 1.1 | 0.9 | 40 | 10 | x/73 | ∘/96 | ∘/83 |
| CEX13 | 45 | 40 | 1.2 | 0.5 | 30 | 5 | x/70 | ∘/92 | ∘/83 |
| CEX14 | 45 | 40 | 1.7 | 0.9 | 40 | 10 | x/66 | ∘/95 | ∘/89 |
| CEX15 | 45 | 10 | 1.2 | 0.3 | 30 | 5 | x/71 | ∘/91 | ∘/86 |
| CEX16 | 45 | 10 | 1.7 | 0.6 | 40 | 10 | x/65 | ∘/95 | ∘/89 |
| CEX17 | 10 | 5 | 0.8 | 0.2 | 30 | 5 | x/75 | ∘/92 | ∘/82 |
| CEX18 | 10 | 5 | 1.2 | 0.4 | 40 | 10 | x/73 | ∘/95 | ∘/86 |
| CEX19 | 10 | 45 | 0.8 | 0.8 | 30 | 5 | x/73 | ∘/94 | ∘/83 |
| CEX20 | 10 | 45 | 1.2 | 1.2 | 40 | 10 | x/74 | ∘/96 | ∘/89 |
| CEX21 | 40 | 45 | 1.0 | 0.8 | 30 | 5 | x/71 | ∘/93 | ∘/83 |
| CEX22 | 40 | 45 | 1.5 | 1.2 | 40 | 10 | x/74 | ∘/96 | ∘/91 |
| CEX23 | 40 | 5 | 1.0 | 0.2 | 30 | 5 | x/76 | ∘/91 | ∘/85 |
| CEX24 | 40 | 5 | 1.5 | 0.4 | 40 | 10 | x/75 | ∘/95 | ∘/87 |

As is clear from Table 1, in all Examples 1 to 8 where as the external additive externally added to the surfaces of the toner base particles, the silica particles and the strontium titanate particles having an average particle diameter of 10 to 40 nm were used, the coverage ratio of the silica particles to the toner base particles was set to 30 to 40% and the coverage ratio of the strontium titanate particles to the toner base particles was set to 5 to 10%, all of the charging stability, the fluidity and the charging rise property were satisfactory.

By contrast, in Comparative Examples 1 and 2 where the coverage ratio of the silica particles was set to 25%, the coverage ratio of the silica particles was excessively low, and thus the charging rise property was unsatisfactory, and the toners were scattered. The total coverage ratio of the external additive to the toner base particles was lowered, and the fluidity was unsatisfactory. On the other hand, in Comparative Examples 5 and 6 where the coverage ratio of the silica particles was set to 45%, the coverage ratio of the silica particles was excessively high, and thus the silica particles were detached from the toner base particles, and the charging stability was unsatisfactory.

In Comparative Examples 3 and 4 where the coverage ratio of the strontium titanate particles was set to 3%, the coverage ratio of the strontium titanate particles was excessively low, and thus contribution to the charging stability is small, and the charging stability was unsatisfactory. On the other hand, in Comparative Examples 7 and 8 where the coverage ratio of the strontium titanate particles was set to 15%, the coverage ratio of the strontium titanate particles was excessively high, and thus the charging rise property was unsatisfactory, and the toners were scattered.

In Comparative Examples 9 to 12 where the average particle diameter of the silica particles was set to 5 nm, the average particle diameter of the silica particles was excessively small, and thus a large variation in the amount of charging was caused by mechanical stress, and the charging stability was unsatisfactory. On the other hand, in Comparative Examples 13 to 16 where the average particle diameter of the silica particles was set to 45 nm, the average particle diameter of the silica particles was excessively large, and thus the silica particles were detached from the toner base particles, and the charging stability was unsatisfactory.

In Comparative Examples 17, 18, 23 and 24 where the average particle diameter of the strontium titanate particles was set to 5 nm, the average particle diameter of the strontium titanate particles was excessively small, and thus a large variation in the amount of charging was caused by mechanical stress, and the charging stability was unsatisfactory. On the other hand, in Comparative Examples 19 to 22 where the average particle diameter of the strontium titanate particles was set to 45 nm, the average particle diameter of the strontium titanate particles was excessively large, and thus the strontium titanate particles were detached from the toner base particles, and the charging stability was unsatisfactory.

It has been confirmed from the results described above that the positively charged silica particles serving as the external additive and the strontium titanate particles which were not positively charged were used, the particle diameters and the coverage ratios of the silica particles and the strontium titanate particles were set within the appropriate ranges and this contributes to enhancement of the charging stability, the fluidity and the charging rise property of the toners.

According to the present disclosure, the positively charged toner which is excellent in the charging stability, the charging rise property and the fluidity is provided.

The present disclosure can be utilized for positively charged toners used in an electrophotographic system. By the utilization of the present disclosure, it is possible to provide a two-component developer including a positively charged toner which can accomplish the simultaneous achievements of the charging stability, the charging rise property and the fluidity.

What is claimed is:

1. A positively charged toner comprising:
a toner base particle; and
an external additive that is adhered to a surface of the toner base particle,
wherein that the external additive includes
a silica particle a surface of which has been positively charged,
a strontium titanate particle a surface of which is not positively charged and
a resin fine particle that is formed of an acrylic resin,
a number average primary particle diameter of the silica particle is equal to or greater than 10 nm but equal to or less than 40 nm,
a number average primary particle diameter of the strontium titanate particle is equal to or greater than 10 nm but equal to or less than 40 nm,
a coverage ratio of the silica particle to a surface region of the toner base particle is equal to or greater than 30% but equal to or less than 40% and
a coverage ratio of the strontium titanate particle to the surface region of the toner base particle is equal to or greater than 5% but equal to or less than 10%.

2. The positively charged toner according to claim 1,
wherein that the toner base particle includes a core-shell structure that includes
a toner core particle and
a shell layer that covers a surface of the toner core particle.

3. The positively charged toner according to claim 1,
wherein that the resin fine particle is formed of a silicone modified acrylic resin.

4. A two-component developer comprising:
the positively charged toner according to claim 1; and
a carrier capable of positively charging the positively charged toner by friction.
